(19) United States
(12) Patent Application Publication
(10) Pub. No.: US 2014/0320316 A1
(43) Pub. Date: Oct. 30, 2014

(54) TRAFFIC LIGHT SYSTEM AND METHOD

(71) Applicant: LUZZATTO & LUZZATTO, Beer Sheva (IL)

(72) Inventor: Natan Peri, Zichron Yaakov (IL)

(21) Appl. No.: 14/343,261

(22) PCT Filed: Sep. 6, 2012
(86) PCT No.: PCT/IL2012/000333

§ 371 Date: Apr. 29, 2014

(30) Foreign Application Priority Data
Aug. 9, 2011 (IL) 215053

(51) Int. Cl. G08G 1/08

(52) U.S. Cl. CPC G08G 1/08
USPC 340/907

(57) ABSTRACT

A traffic light system that comprises traffic lights for directing the passage of vehicles through art intersection; a control unit with a signal controller in communication with each of the plurality of traffic lights, a signal controller transceiver with a directional antenna, and a signal controller interface processing unit (SCIPU) in communication with the signal controller and with the signal controller transceiver; and a vehicle unit provided with a vehicle processing unit and a vehicle transceiver, which comprising a forwardly mounted directional antenna. The signal controller transceiver repeatedly transmits a wireless interrogating signal to approaches of the intersection, which identifies the control unit. The vehicle transceiver transmits a wireless return signal modulated by the vehicle processing unit with an identifier of the control unit and of the vehicle unit to the signal controller transceiver after having received the interrogating signal, reception of the return signal and an increase in RSSI value with time of the return signal being indicative that a vehicle carrying the vehicle unit is located upstream to the intersection. The SCIPU counts a real-time number of vehicles located on each of the one or more approaches and to allocate duration of green light time for each of the plurality of traffic lights in response to the real-time number of vehicles located on a corresponding approach.

### FIELD OF THE INVENTION

The present invention relates to the field of traffic control systems. More particularly, the invention relates to a system and method for dynamically allocating green light time of a traffic light at a given intersection.

### BACKGROUND OF THE INVENTION

Many prior art systems are known for dynamically allocating green light time of a traffic light for enabling free passage of a vehicle through a given intersection.

For example, U.S. Pat. No. 7,557,731 discloses a system and method for regulating the flow of traffic at a roadway intersection having one or more traffic signals by positioning a processor in the vicinity of the intersection to store cycle times of the traffic flow directions, mounting an RFID reader in the vicinity of each traffic signal in communication with the processor, mounting a plurality of RFID tags in the vicinity of a license plate so as to be within the communication range of an RFID reader at the intersection and so that the RFID readers interrogate the RFID tags of the vehicles, calculating an unused time slice of the cycle time for at least one of the traffic flow directions at the intersection; and, reducing the cycle time for the traffic flow.

Likewise JP 2004013199, JP 2004287983, JP 2005352615, JP 2008102738, KR 20040022306, US 2002/0145541, US 200610202862, US 2008/0150759 and US 2009/0231160 also disclose a system for regulating the flow of traffic by means of a radio transceiver mounted in the vicinity of an intersection and a radio transceiver mounted on a vehicle.

These prior art systems are only capable of accurately determining that no vehicles are located in a particular lane approaching the intersection and to allocate the flow of traffic accordingly: however, these prior art systems incapable of accurately determining how many vehicles are waiting in line at a given intersection since many intersections in urban areas are spaced from each other by a distance of 50-100 m, a distance which is in the range of an RFID reader. Thus the prior art system may arrive at an incorrect conclusion that some vehicles are located at an intersection and allocate green light time of the traffic light at that intersection in response to the incorrect conclusion, while in reality those vehicles are located at an adjacent intersection. On the other hand, the RFID reader will not be able to be able to receive information from all of the vehicles at a given intersection if its range is excessively short.

It is an object of the present invention to provide a system and method for accurately determining the number of vehicles that are approaching an intersection in each direction.

It is an additional object of the present invention to provide a system and method for dynamically and accurately allocating green light time of a traffic light at a given intersection.

It is an additional object of the present invention to provide a system and method for accurately allocating green light time of a traffic light at a given intersection by means of a long range transceiver, e.g. having a range longer than 100 m, while disregarding signals transmitted from vehicles located at an adjacent intersection.

Other objects and advantages of the invention will become apparent as the description proceeds.

### SUMMARY OF THE INVENTION

The present invention is directed to a method for dynamically and accurately allocating green light time of a traffic light at an intersection, comprising the steps of repeatedly transmitting a wireless, intersection-specific interrogating signal, i.e. one modulated with an identifier of the intersection and optionally of the approach to which the interrogating signal propagates, by means of a directional antenna from a control unit mounted in a central region of the intersection to an approach to the intersection; receiving the interrogating signal by means of a directional antenna forwardly mounted on each of a plurality of vehicles located in the vicinity of the intersection; disregarding the interrogating signal when the vehicle unit determines that the interrogating signal has been originated from a vehicle unit; transmitting a vehicle-specific return signal, i.e. one modulated with an identifier of the vehicle, from each of the plurality of vehicles by means of a corresponding forwardly mounted directional antenna of a vehicle unit to the antenna of the control unit, the return signal being modulated with an identifier of a received interrogating signal; disregarding the return signal when the control unit determines that the identifier of the interrogating signal with which the return signal is modulated has been originated from another control unit downstream to the control unit; disregarding the return signal when the control unit determines that the values of all received signal strength indications from the vehicle unit are lower than a predetermined threshold, or when the control unit determines that the identifier of the interrogating signal with which the return signal is modulated has been originated from another approach of the intersection, or when the control unit determines that the value of received signal strength indication from the vehicle unit decreases with time; receiving additional return signals by the control unit and determining that a vehicle is located on the approach if all of the additional return signals transmitted by its vehicle unit which are received and not disregarded by the control unit are modulated with the identifier of the interrogating signal; counting a real-time number of vehicles located on the approach; and allocating green light time of a traffic light for directing traffic through the approach in response to the real-time number of vehicles located on the approach.

If a vehicle unit transmits first and second return signals which are modulated with the identifier of first and second interrogating signals, respectively, to a first control unit, it is determined that the vehicle carrying the vehicle unit is located at an “approach”, i.e. a lane or group of lanes along which a vehicle travels leading to, and prior to crossing, a given intersection, associated with a second control unit and a second intersection and upstream from the first control unit and a corresponding first intersection, yet the vehicle unit is within transmission range of the first control unit. Due to the proximity of the first and second control units and the sufficiently long range of the transceiver of each control unit, the vehicle unit receives the first and second interrogating signals, and quickly responds by transmitting the first and second return signals, respectively. Since the first control unit receives from the vehicle unit not just the first return signal modulated with the identifier of the interrogating signal, but also a second return signal modulated with the identifier of a second interrogating signal which has been transmitted from the second control unit mounted in a second intersection upstream to the first intersection, the first control unit disregards the first and second return signals received from the vehicle unit.

However, if the vehicle unit does not transmit second return signals to the first control unit, the first control unit determines that the vehicle is located on an approach to the first intersection. Thus the vehicle is considered when the real-time number of vehicles located on the approach is counted.

If the vehicle unit transmits first and second return signals to the second control unit located upstream to the first control unit, the second control unit is operable to disregard the first return signal, determining that the vehicle carrying the vehicle unit is located at an approach to the second intersection with which the second control unit is associated.

As referred to herein, “upstream” means located in a direction capable of reaching an intersection when traveling with the flow of traffic, and “downstream” means separated from the intersection in a direction along the flow of traffic that leads away from the intersection. When the intersection, for example, is located in an urban area closely separated from adjacent intersections, a vehicle exiting a first intersection is located “downstream” from the first intersection and “upstream” from the second intersection when traveling on the approach to the second intersection.

Accordingly, the first control unit will receive a return signal from the vehicle unit only if the vehicle is located upstream from the first intersection. Since the directional antenna is forwardly mounted on the vehicle, the return signal will not be received by the first control unit when the vehicle unit is located downstream from the first control unit.

Accordingly, the first control unit is operable to disregard the return signal if the value of received signal strength indication (RSSI) decreases with time;

In one aspect, the interrogating signal is modulated with a unique binary code (UBC) that identifies the control unit, and the return signal is modulated with the UBC and with a vehicle binary code (VBC) that identifies the vehicle unit.

In one aspect, the UBC also identifies the approach to which the interrogating signal propagates.

In one aspect, the VBC is also based on an instantaneous travel direction of the vehicle detected by means of one or more vehicular sensors and/or on a vehicle type.

In one aspect, the identifier based on an instantaneous travel direction of the vehicle associates the vehicle to a given signal group and the green light time is allocated in response to the real-time number of vehicles located on the approach and associated with the given signal group.

In one aspect, the green light time is allocated with respect to a number of vehicle size units per lane for each signal group waiting at the approach, each vehicle type being associated with a corresponding number of vehicle size units.

In one aspect, the green light time is allocated by compiling, for each signal group, a list of vehicles waiting for green light time; sequentially removing a vehicle from the waiting list after the vehicle crosses the intersection; comparing, for each signal group, a determined number of vehicles on the waiting list with a number of vehicles that have crossed the intersection; and adjusting the allocated green light time if a difference between the determined number of vehicles on the waiting list and the number of vehicles that have crossed the intersection is greater than, or less than, a predetermined range of values.

In one aspect, the adjusted green light time is corrected by considering maximum green light time or maximum red light time. The waiting list is adjusted according to the adjusted green light time.

In one aspect, the green light time is terminated when all vehicles on the waiting list have crossed the intersection before the allocated green light has elapsed.

In one aspect, the green light time is terminated when the allocated green light has elapsed.

The present invention is also directed to a traffic light system, comprising a plurality of traffic lights for directing the passage of vehicles through an intersection; a control unit mounted in a central region of the intersection, the control unit comprising a signal controller in communication with each of the plurality of traffic lights, a signal controller transceiver having a directional antenna, and a signal controller interface processing unit (SCIPU) in communication with the signal controller and with the signal controller transceiver; and a vehicle unit provided with a vehicle processing unit and a vehicle transceiver, the vehicle transceiver comprising a forwardly mounted directional antenna.

The signal controller transceiver is operable to repeatedly transmit to one or more predetermined approaches of the intersection, by means of its directional antenna, a wireless interrogating signal which identifies the control unit. The vehicle transceiver is operable to transmit, by means of the forwardly mounted directional antenna, a wireless return signal modulated by the vehicle processing unit with an identifier of the control unit and of the vehicle unit to the signal controller transceiver after having received the interrogating signal, reception of the return signal and an increase in RSSI value with time of the return signal being indicative that a vehicle carrying the vehicle unit is located upstream to the intersection. The SCIPU is operable to count a real-time number of vehicles located on each of the one or more approaches and to allocate a duration of green light time for each of the plurality of traffic lights in response to the real-time number of vehicles located on a corresponding approach. The signal controller is operable to control operation of the plurality of traffic lights associated with the intersection in accordance with the allocated green light time.

In one embodiment, the SCIPU is also operable to disregard a return signal when the control unit determines that the identifier of an interrogating signal with which the return signal is modulated originated from another control unit downstream to the control unit; and to determine that a vehicle is located on an approach to the intersection if all return signals transmitted by its vehicle unit which are received and not disregarded by the control unit are modulated with the identifier of an interrogating signal transmitted by the control unit. In one aspect, the interrogating signal is modulated with both an identifier of the control unit from which it was transmitted and with an identifier of the approach to which it propagatable.

In one aspect, the return signal is also modulated with an identifier of an instantaneous travel direction of the vehicle which associates the vehicle to a signal group and with an identifier of a vehicle type

In one aspect, the signal controller transceiver is a signal controller radio transceiver for transmitting and receiving radio wave signals.

In one aspect, the signal controller transceiver comprises a plurality of stationary directional antennas, an interrogating signal transmitted from each of the antennas being propagatable to a different approach.

In one aspect, the directional antenna of the control unit is rotatable to predetermined discrete angular positions, from each of the predetermined angular positions the interrogating signal is propagatable to a different approach.

In one aspect, both the directional antenna of the control unit and the directional antenna of the vehicle unit have a limited spatial sector.

In one aspect, the SCIPU is also operable to determine a real-time number of vehicles that are waiting at an approach to an upstream intersection. The SCIPU is operable to count a real-time number of vehicles that are waiting at an approach to an upstream intersection by temporarily disregarding all return signals modulated with the identifier of the interrogating signal transmitted by the control unit of an intersection downstream to the upstream intersection.

In one aspect, the SCIPU is operable to disregard a return signal when the control unit determines that the value of RSSI decreases with time;

In one aspect, the vehicle processing unit is operable to disregard an interrogating signal originated from another vehicle processing unit;

In one aspect the SCIPU is operable to disregard a return signal when the control unit determines that the values of all received signal strength indications from the vehicle unit is lower than a predetermined threshold

In one aspect the SCIPU is operable to disregard a return signal at a certain approach of the intersection when the control unit determines that the identifier of the interrogating signal with which the return signal is modulated originated from another approach of the intersection

In one aspect, the vehicle processing unit is operable to modulate the return signal with a randomly generated identifier of the vehicle unit.

### BRIEF DESCRIPTION OF THE DRAWINGS

In the drawings:

FIG. 1 is a schematic illustration of a traffic light system according to one embodiment of the present invention, shown with respect to one approach to an intersection;

FIG. 2 is a method for accurately determining the number of vehicles that are approaching an intersection;

FIG. 3 is a method for dynamically and accurately allocating green light time of a traffic light at an intersection, according to one embodiment of the invention;

FIG. 4 is a schematic illustration of the traffic light system of FIG. 1, shown with respect to three intersections; and

FIGS. 5a-d are schematic illustrations of the antenna of a control unit according to another embodiment of the present invention, shown in four different positions, respectively.

### DETAILED DESCRIPTION OF PREFERRED EMBODIMENTS

The present invention is a system and method for dynamically and accurately allocating green light time of a traffic light at a given intersection by counting the number of vehicles that are located in an approach to a given intersection. A signal controller radio transceiver (SCRT) of a stationary intersection mounted control unit (CU) receives signals transmitted by the on board vehicle radio transceiver (VRT) of vehicles located at an approach to this intersection and also of vehicles located at an approach to upstream intersections. A signal controller interface processing unit (SCIPU) of the CU at the given intersection is operable to disregard the signals transmitted by vehicles located at one or more upstream intersections. The number of upstream directed vehicles is thereby counted, allowing the CU to dynamically allocate green light time of a corresponding traffic light in accordance with traffic volume, traffic arrangement, for example per approach or per signal group, and design preferences.

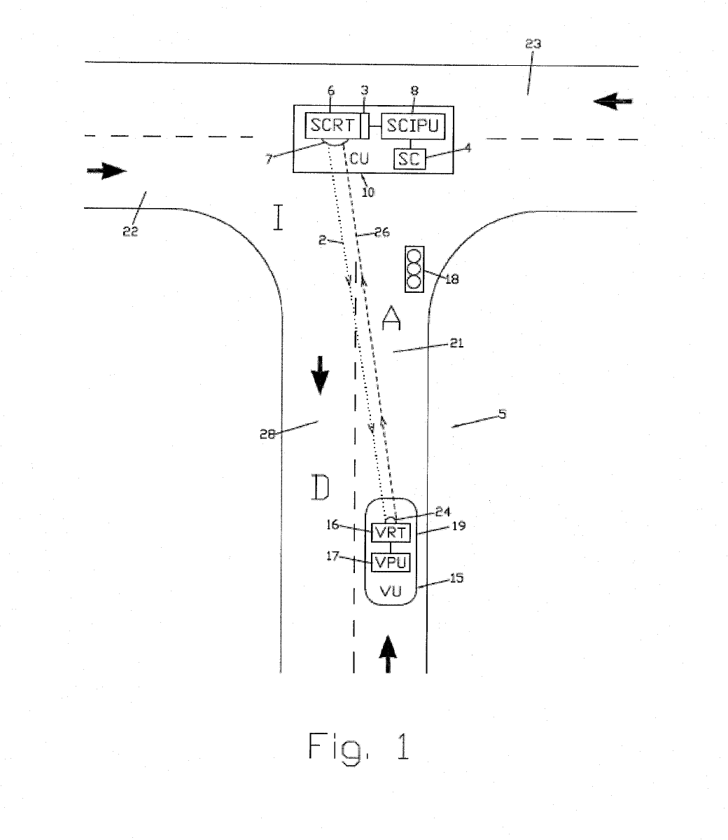

FIG. 1 schematically illustrates a system for determining the number of vehicles that are located at an intersection I, and for thereby dynamically and accurately allocating green light time of a traffic light (TL) 18 at the intersection, according to one embodiment of the present invention, and is generally designated by numeral 5. System 5 comprises stationary CU 10 and vehicle unit (VU) 15.

CU 10 mounted in a central region of intersection I comprises a signal controller (SC) 4 in communication with each TL 18 of intersection I, whether by a wired connection or by wireless means, for regulating the flow of traffic through intersection I by dynamically allocating green light time for each TL 18, during which vehicles 19 traveling along a lane 21 are allowed to cross intersection I. CU 10 also comprises a signal controller radio transceiver (SCRT) 6 for communicating with VU 15, as will be described hereinafter, and SCIPU 8 in data communication with SCRT 6 and SC 4 wirelessly or by means of a wired connection. SCIPU 8 may also be in data communication with another computer or server.

SCRT 6 comprises a CPU 3 and a directional antenna 7 for transmitting a radio wave signal 2 which is limited to predetermined spatial sectors, so that signal 2 will be assured of propagating to all approaches associated with intersection I and is preferably restricted from propagating to downstream regions of intersection I. Although signal 2 is shown to be transmitted only to lane 21 for purposes of clarity, it will be appreciated that signal 2 may also be transmitted to other approaches associated with intersection I, including lanes 22 and 23.

An intersection may have a plurality of approaches, each of which is oriented in a different direction. Each approach may be associated with up to four signal groups, i.e. right turn, straight movement through the intersection, left turn, and public transport lane, while the instantaneous signal group of vehicles traveling along a given lane group is directed by a corresponding traffic light. An approach may be associated with a single signal group, for example it may have two lanes while the same light is displayed on all traffic lights of the approach. In this example, the approach also has a single lane group. Alternatively, an approach may have three lane groups, each of which being associated with a different instantaneous signal group, for example one lane being associated with a right turn signal group, two lanes associated with the straight movement signal group, and one lane associated with a left turn signal group.

VU 15 comprises a vehicle radio transceiver (VRT) 16 and a vehicle processing unit (VPU) 17 in communication with VRT 16. VRT 16 comprises a forwardly positioned directional antenna 24, which can direct radio wave signal 26 to SCRT 6 only when vehicle 19 is located in the approach upstream region A of lane 21, but not in the downstream region D of lane 28 thereof. The spatial sector of signal 26 is selected such that it will be assured of propagating to SCRT 6 at all intended positions of SCRT 6 relative to an approach. When VRT 16 transmits a return signal 26 to SCRT 6 after having received a signal 2 and the value of RSSI of signal 26 increases with time, SCIPU determines that vehicle 19 is located in approach region A of lane 21. However, a vehicle traveling in lane 28, which is opposite to lane 21, in a downstream direction to intersection I will not be able to transmit a return signal to SCRT 6 even if it receives signal 2 since its antenna is pointing in an opposite direction to the SCRT of CU 10. The SCIPU may be operable to disregard a return signal if the value of RSSI decreases with time

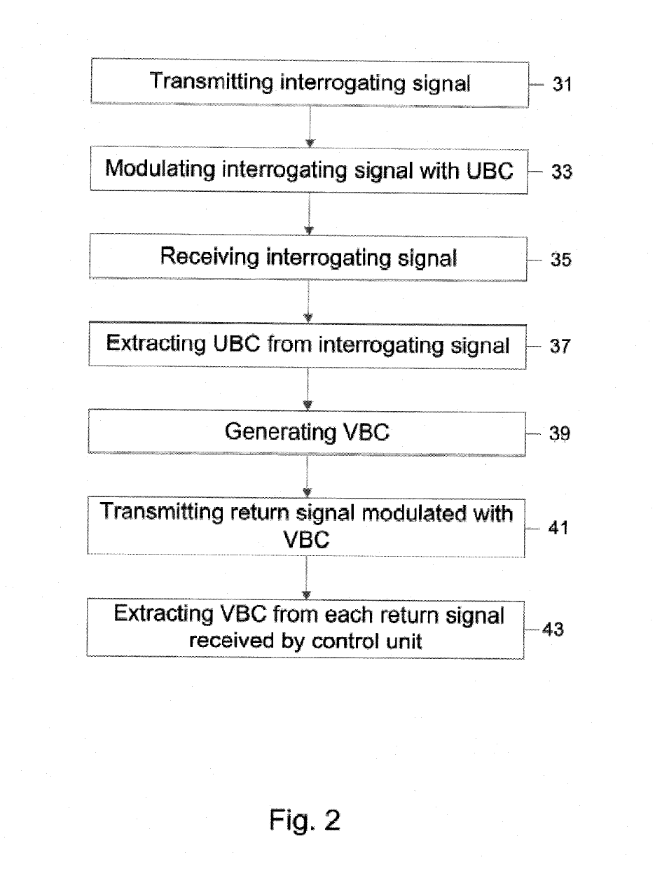

FIG. 2 illustrates a method for accurately determining the number of vehicles that are approaching an intersection in each direction. In step 31, the SCRT repeatedly transmits spatially limited interrogating signals, e.g. once a second, to all approaches of an intersection. In step 33, the CPU of the SCRT generates a unique binary code (UBC) that modulates the interrogating signal so that the CU and the target approach can be identified. In step 35, the VRT of a vehicle in an approach region receives the interrogating signal and demodulates the same in step 37 in order to extract the UBC. In step 39, the VPU generates a vehicle binary code (VBC) based on a vehicle ID, an instantaneous travel direction of the vehicle detected by means of one or more vehicular sensors in communication with the VPU, e.g. the blinking direction indicator, a vehicle type, such as a small passenger vehicle, minivan, bus, truck and semi-trailer, and the extracted UBC by means of a dedicated decoding key. The VRT then modulates the return signal with the VBC in step 41 and transmits the return signal within a predetermined time following the transmission of the interrogating signal. The SCIPU extracts the VBCs from all return signals received by the SCRT in step 43, indicating the number of vehicles located at each approach. As the interrogating and return signals are modulated with the target approach identification, the SCIPU is able to determine how many vehicles are located at each approach. Since the VBC defines an instantaneous travel direction of a vehicle, the SCIPU is able to categorize the vehicles at each approach into different signal groups.

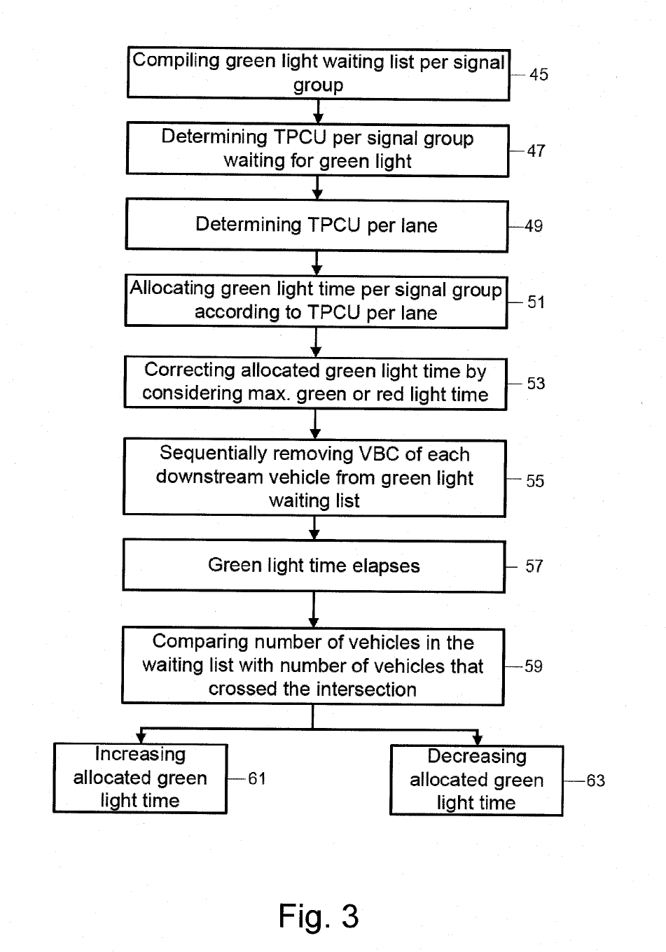

FIG. 3 illustrates a method for dynamically and accurately allocating green light time of a traffic light at a given intersection. The SCIPU is programmed with an algorithm that optimizes the green light time at each approach, and for each signal group thereof. The SC controls the operation of all traffic lights associated with the intersection in accordance with the allocated green light time.

Approximately at the end of the red light display, the SCIPU compiles a waiting list in step 45, based on the received VBCs, of the number and type of vehicles for each signal group that are waiting for a green light. Each vehicle type has a predetermined number of passenger car units (PCUs), depending on its size. For example, a passenger vehicle will have a smaller number of PCUs than a truck. The SCIPU then determines in step 47 the total passenger car units (TPCU) for each signal group that are waiting for a green light, equal to the sum of each product of the number of a given vehicle type and the corresponding PCU. The TPCU per lane is determined in step 49 by dividing the TPCU by the number of lanes associated with each signal group. A nominal green light time is then allocated for each signal group in step 51 as a function of the TPCU per lane.

If the SCIPU determines for any signal group that the allocated green light time is greater than a predetermined maximum green light time, or a calculated red light time, i.e. waiting time, is greater than a predetermined value, the SCIPU accordingly corrects the allocated green light time in step 53 and also reduces the number of VBCs in the waiting list by a predetermined value in compensation for the reduced allocated green light time.

When the green light is displayed and vehicles cross the intersection, the VBC (that originates from a vehicle unit mounted on the vehicle) of each vehicle that is located downstream from the intersection is no longer received by the control unit or the value of RSSI decreases with time, thereby implicating that the vehicle is moving downstream away from the intersection. The SCIPU therefore sequentially removes in step 55 the VBC of each downstream vehicle from the green light waiting list until the allocated green light time elapses in step 57 or all vehicles on the waiting list have crossed the intersection.

After a predetermined number of cycles, the total number of vehicles that have crossed the intersection is compared in step 59 with the total number of vehicles in the waiting list that were waiting for green light time, by referring to the corresponding VBCs. If the difference between the total number of vehicles in the waiting list that were waiting for green light time and the total number of vehicles that have crossed the intersection is greater than a predetermined threshold, the allocated green light time per PCU is increased in step 61 in order to compensate for stationary or excessively slow moving vehicles that are blocking the passage of vehicles along one or more lanes of the signal group, for example due to an accident or the passage of a truck. If, however, the total number of vehicles that were waiting for green light time is less than or equal to the total number of vehicles that have crossed the intersection, indicating that the allocated green light time is longer than required, the allocated green light time per PCU is decreased in step 63, but not less than a predetermined value.

This method is repeated for each signal group of each approach to form a cycle.

In a traffic light system wherein two or more control units are synchronized, the allocated green light time of a first signal group at a first intersection can be determined in response to the number of vehicles of the first signal group, or of any other signal group, that are waiting at a second intersection adjacent to, or distant from, the first intersection.

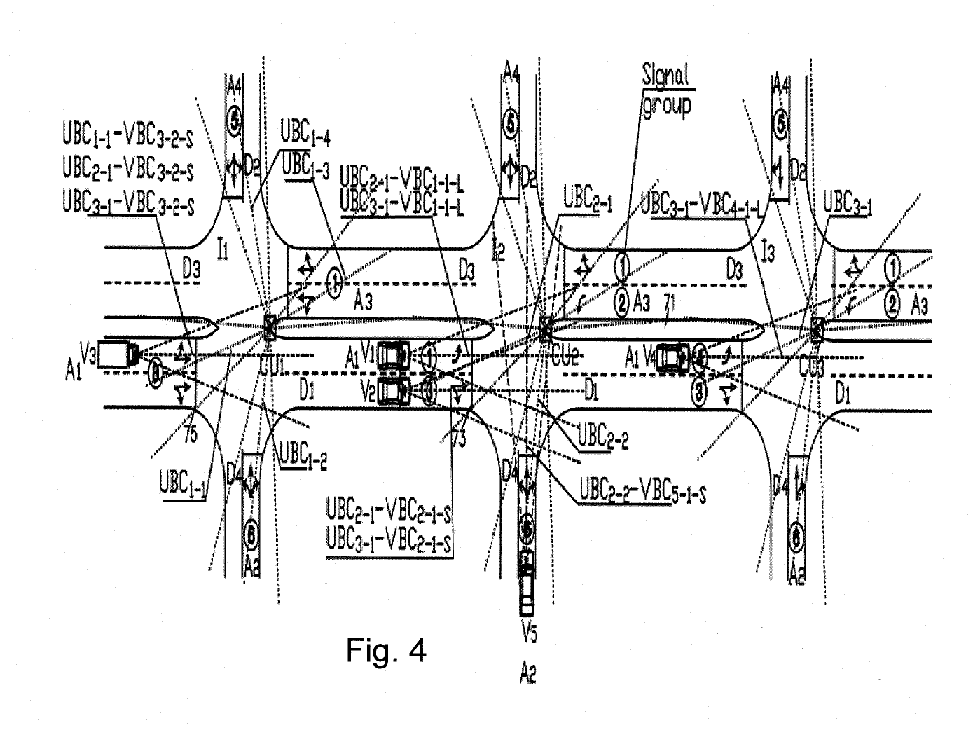

Another aspect of the inventiveness of the present invention may be appreciated by referring to FIG. 4, which illustrates an arrangement of three adjacent intersections I₁₋₃, of an urban area, in a central region of each of which are mounted control units CU₁₋₃, respectively, for example on traffic island 71. Each of these intersections is shown to have four approaches A₁₋₄ and four downstream regions D₁₋₄, a downstream region being contiguous with an approach. Approaches A₁ and A₃ and downstream regions D₁ and D₃ are subdivided into two lanes, each of these approaches being associated with a different signal group. Each of approaches A₂ and A₄ and downstream regions D₂ and D₄ has only one lane.

Five vehicles V₁₋₅ are shown. Vehicles V₁ and V₂ are traveling on the left and right lanes, respectively, of approach A₁ of intersection I₂. Vehicles V₃ and V₄ are traveling on the left lane of approach A₁ of intersections I₁ and I₃, respectively. Vehicle V₅ is traveling on approach A₂ of intersection I₂.

As explained hereinabove, each vehicle is equipped with a forwardly positioned directional antenna 24 (FIG. 1) for transmitting a return signal of a limited spatial sector, which is schematically illustrated as a sector of dashed lines and is modulated with a VBC. Each VBC is designated with a subscript which refers to the vehicle from which the VBC was generated. Due to the proximity of CU₁₋₃ and the relatively long range of each corresponding SCRT, the SCRT will receive a VBC from vehicles traveling along approaches of other intersections, for example the SORT of CU₃ will receive the VBC transmitted by the VRT of vehicles V₁₋₃ in addition to that of vehicle V₄. Nevertheless, the SCIPU of CU₃ is able to determine that vehicles V₁₋₃ are traveling on remote approaches.

Each CU may comprise four directional antennas 7 (FIG. 1) for transmitting an interrogating signal of a limited spatial sector, which is schematically illustrated as a sector of dotted lines and spans an angular region of no more than 90 degrees, in order to propagate to a corresponding approach. Each antenna has a different identification, and therefore the SCIPU is able to distinguish between the interrogating signals transmitted from two or more SCRTs. For example, the four interrogating signals transmitted by the four antennas, respectively, of CU₂ will be designated as UBC₂₋₁₋₄, the left subscript referring to the intersection designation and the right subscript referring to the approach designation. Accordingly, the SCIPU of CU₂ will be able to determine after receiving a return signal UBC₂₋₁-VBC₂ that vehicle V₂ is located in approach A₁ and that vehicle V₅ is located in approach A2 after receiving a return signal UBC2-2-VBC5.

Due to the high sensitivity of the SCRT's and vehicle units and the limited impedance of non directional receiving angles of directional antennas, there may be some leaks of radio waves between vehicle units and SCRT's not located at the same approach.

Interrogating signal UBC₂₋₂ received by vehicle units V1 and V2 will generate return signals UBC₂₋₂-VBC₁, UBC₂₋₂-VBC₂, respectively. Interrogating signal UBC₂₋₁ received by vehicle units V1 and V2 will generate return signals UBC₂₋₁-VBC₁, UBC₂₋₁-VBC₂ respectively. However these return signals received at the antennas of approaches 2,3,4 have all a low RSSI which is less than a predetermined threshold and therefore will be disregarded by the SCIPU of CU₂. The SCIPU of CU2 is operable to disregard any return signal with an identifier of the interrogating signal with which return signal is modulated that originated from another approach of CU₂. Accordingly return signals UBC₂₋₂-VBC₁, UBC₂₋₂-VBC₂ received at the antenna of approach 1 of CU₂ will be disregarded.

Each VBC may be modulated with three identifiers: (1) the vehicle identification number, (2) a vehicle type having a characteristic number of PCUs, and (3) the travel direction of the vehicle. Accordingly, each VBC transmitted by a corresponding VRT may be designated by VBC_{XXX-N-y}, where the subscript XXX refers to the vehicle identification number, the subscript N refers to the vehicle type, and the subscript Y refers to the travel direction, whether R for a right turn, S for straight movement, or L for a left turn.

The instantaneous travel direction of the vehicle is generally detected by means of the blinking direction indicator, which the driver is encouraged to employ in order to be allocated a longer green light time. The VBC will be modified upon changing the instantaneous travel direction of the vehicle, for example from a left turn signal group to a right turn signal group.

The following example describes the processing of signals carried out by control unit CU₂. Since a return signal transmitted by vehicles V₁, and V₂, which are passenger cars having a designated vehicle type of 1 and are located at approach A₁ of intersection I₂, is modulated with the UBC associated with the interrogating signal that its VRT received from CU₂, the first return signal transmitted by vehicles V₁ and V₂ will be designated as UBC₂₋₁-VBC_{1-1-L} and UBC₂₋₁-VBC_{2-1-S}, respectively. However, vehicles V₁ and V₂ also receive interrogating signals from CU₃ and will therefore transmit return signals UBC₃₋₁-VBC_{1-1-L} and UBC₃₋₁-VBC_{2-1-S}, respectively. Due to the proximity of CU₂ and CU₃, CU₂ will also receive the four return signals UBC₂₋₁-VBC_{1-1-L}, UBC₂₋₁-VBC_{2-1-S}, UBC₃₋₁-VBC_{1-1-L} and UBC₃₋₁-VBC_{2-1-S}. The SCIPU of CU₂ is operable to disregard a return signal modulated with a UBC originated from a downstream CU. Thus CU₂ will disregard UBC₃₋₁-VBC_{1-1-L} and UBC₃₋₁-VBC_{2-1-S}.

CU₂ also transmits an interrogating signal UBC₂₋₁ to vehicle V₃. Vehicle V₃, which is a truck having a designated vehicle type of 2, receives three interrogating signals: UBC₁₋₁, UBC₂₋₁ and UBC₃₋₁ and transmits three return signals: UBC₁₋₁-VBC_{3-2-S}, UBC₂₋₁-VBC_{3-2-S} and UBC₃₋₁-VBC_{3-2-S}. The SCIPU of CU₂ is operable to disregard all of these return signals having a common VBC since one of the UBCs modulated with the common VBC originated from an upstream CU, i.e. UBC₁₋₁.

The SCIPU of CU₂ is therefore operable to determine the number of vehicles at each signal group waiting at stop line 73 of intersection I₂, approach A₁, by implementing the aforementioned method of (1) disregarding a return signal modulated with a UBC originated from a downstream CU, and (2) disregarding all return signals having a common VBC when one of the UBCs modulated with the common VBC originated from an upstream CU.

The SCIPU of CU₂ is also able to determine how many vehicles are waiting behind a stop line 75 at an approach to I₁ or at an approach to any other upstream intersection when the corresponding traffic light displays a red light.

This CU of the corresponding intersection will transmit, wirelessly or by a wired connection, this information to the CU of adjacent intersections in order to suitably allocate the green light time of each corresponding traffic light or to synchronize the operation of the traffic lights of adjacent intersections.

Alternatively, a first control unit located at a first intersection may count the number of vehicles waiting for green light time at an approach to an upstream second intersection by disregarding return signals modulated with the identifier of the interrogating signal transmitted by the first control unit and, if applicable, control units located between the first and second control units. The first control unit is then able to determine that a vehicle is located on this approach to the second intersection if all additional return signals that were transmitted by its vehicle unit and not disregarded by the first control unit are modulated with the identifier of an interrogating signal transmitted by the second control unit. The first control unit is then able to accurately count the number of vehicles waiting for green light time at this approach to the second intersection.

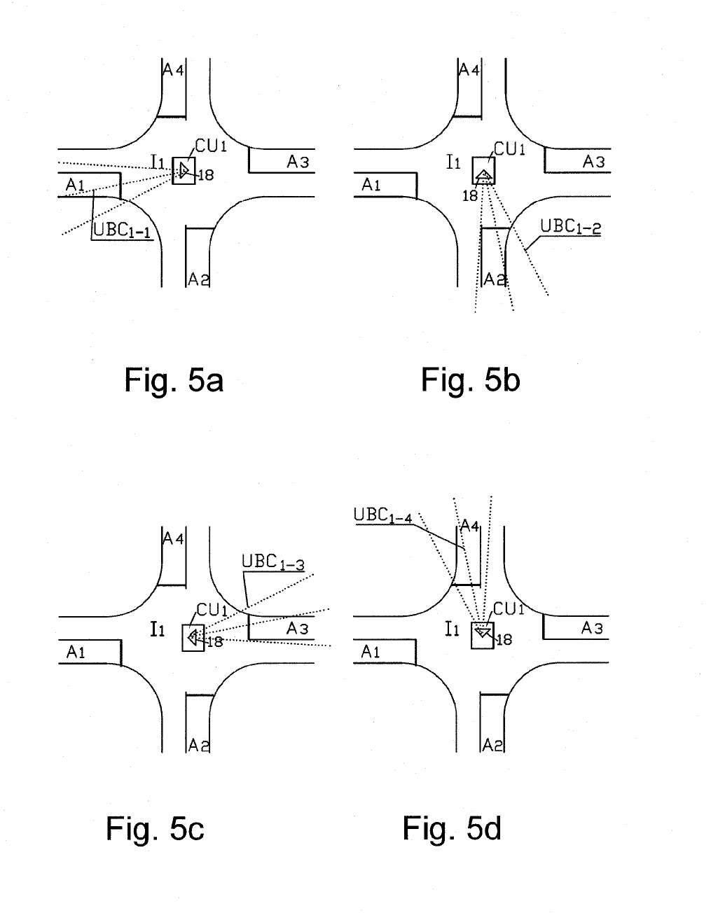

FIGS. 5a-d illustrate another embodiment of the invention wherein the CU employs a rotating antenna 81 which rotates in accordance with a predetermined duty cycle by means of a motor and control signals generated by the SCIPU. During the duty cycle, rotating antenna 81 sequentially rotates to predetermined discrete angular positions, from each of which the interrogating signal propagates to a different approach. The rotational speed of antenna 81 may be constant, or alternatively, may change from a first predetermined speed when rotating from a first to a second angular position and then to a second predetermined speed when rotating from a second to a third angular position, for example in response to the previously determined number of vehicles located at the given approach.

The interrogating signal continues to be spatially limited, and the CPU of the SCRT generates a different UBC for each corresponding angular position of antenna 81. Thus when antenna 81 is disposed at the first angular position shown in FIG. 5a, the interrogating signal modulated with UBC₁₋₁ propagates to approach A₁. Antenna 81 is then rotated, e.g. in a counterclockwise direction as shown, to the second angular position shown in FIG. 5b, and an interrogating signal modulated with UBC₁₋₂ propagating to approach A₂ is consequently generated. Similarly, antenna 81 sequentially rotates to the third and fourth angular positions shown in FIGS. 5c and 5d, respectively, and transmits the interrogating signal modulated with UBC₁₋₃ and UBC₁₋₄, respectively. The antenna is then continuously rotated to the first angular position to complete the duty cycle and to commence another cycle.

In another embodiment, a VBC may be randomly generated in order to maintain anonymity of the corresponding vehicle. When the VRT of a VU receives an interrogating signal, the VPU generates in response a VBC with a randomly generated vehicle identification number. The CU accordingly allocates the green light time with respect to a return signal modulated with the VBC having a randomly generated vehicle identification number.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A method for dynamically and accurately allocating green light time of a traffic light at an intersection, comprising the steps of
a) repeatedly transmitting a wireless, intersection-specific interrogating signal by means of a directional antenna from a control unit mounted in a central region of said intersection to an approach to said intersection, wherein said interrogating signal is modulated with a unique binary code (UBC) that identifies said control unit;
b) receiving said interrogating signal by means of a directional antenna of a vehicle unit forwardly mounted on each of a plurality of vehicles located in the vicinity of said intersection;
c) disregarding said interrogating signal when the vehicle unit determines that said interrogating signal has been originated from another vehicle unit;
d) transmitting a vehicle-specific return signal from each of said plurality of vehicles by means of a corresponding forwardly mounted directional antenna of a vehicle unit to said antenna of said control unit, said return signal being modulated with a vehicle binary code (VBC) that identifies the vehicle and a vehicle type thereof associated with a corresponding number of characteristic vehicle size units, and with the UBC of a received interrogating signal;
e) disregarding said return signal when said control unit determines that the UBC of said interrogating signal with which said return signal is modulated originated from another control unit downstream or upstream to said control unit;
f) repeating steps d) and e) for additional return signals and determining that a vehicle is located on said approach if all of said additional return signals transmitted by its vehicle unit which are received and not disregarded by said control unit are modulated with the UBC of said interrogating signal;
g) counting a real-time number of vehicles and of corresponding vehicle size units located at said approach, based on the number of received return signals that have not been disregarded; and
h) allocating green light time of a traffic light for directing traffic through said approach in response to the real-time number of vehicles size units located at said approach.

2. (canceled)

3. The method according to claim 1, wherein the UBC also identifies the approach to which the interrogating signal propagates.

4. The method according to claim 1, wherein the VBC also has an identifier based on an instantaneous travel direction of the vehicle detected by means of one or more vehicular sensors and on a vehicle type.

5. The method according to claim 4, wherein the identifier based on an instantaneous travel direction of the vehicle associates the vehicle to a given signal group and the green light time is allocated in response to the real-time number of vehicles size units located on the approach and associated with said given signal group.

6. (canceled)

7. The method according to claim 5, wherein the green light time is allocated by:
i. compiling, for each signal group, a list of vehicles waiting for green light time;
ii. sequentially removing a vehicle from the waiting list after said vehicle crosses the intersection;
iii. comparing, for each signal group, a determined number of vehicles on the waiting list with a number of vehicles that have crossed the intersection; and
iv. adjusting the allocated green light time if a difference between the determined number of vehicles on the waiting list and the number of vehicles that have crossed the intersection is greater than, or less than, a predetermined range of values.

8. The method according to claim 7, wherein the adjusted green light time and the number of vehicles on the waiting list are corrected by considering maximum green light time or maximum red light time.

9. The method according to claim 7, wherein the green light time is terminated when all vehicles on the waiting list have crossed the intersection before the allocated green light has elapsed, or when the allocated green light has elapsed.

10. (canceled)

11. A traffic light system, comprising:
a) a plurality of traffic lights for directing the passage of vehicles through an intersection;
b) a control unit mounted in a central region of said intersection, said control unit comprising a signal controller in communication with each of said plurality of traffic lights, a signal controller transceiver having a directional antenna, and a signal controller interface processing unit (SCIPU) in communication with said signal controller and with said signal controller transceiver; and
c) a vehicle unit provided with a vehicle processing unit and a vehicle transceiver, said vehicle transceiver comprising a forwardly mounted directional antenna,
wherein said signal controller transceiver is operable to repeatedly transmit to one or more predetermined approaches of said intersection, by means of its directional antenna, a wireless interrogating signal which is modulated with a unique binary code (UBC) that identifies said control unit,
wherein said vehicle transceiver is operable to transmit, by means of said forwardly mounted directional antenna, a wireless return signal modulated by said vehicle processing unit with the UBC of a received interrogating signal and with a vehicle binary code (VBC) that identifies the vehicle and a vehicle type thereof associated with a corresponding number of characteristic vehicle size units, to said signal controller transceiver after having received said interrogating signal, reception of said return signal and an increase in RSSI value with time of said return signal being indicative that a vehicle carrying said vehicle unit is located upstream to said intersection,
wherein said SCIPU is operable to:
i. disregard a return signal when said control unit determines that the UBC of an interrogating signal with which said return signal is modulated originated from another control unit downstream or upstream to said control unit;
ii. determine that a vehicle is located on an approach to the intersection if all return signals transmitted by its vehicle unit which are received and not disregarded by said control unit are modulated with the identifier of an interrogating signal transmitted by said control unit; and
iii. count a real-time number of vehicles and of corresponding vehicle size units located at each of said one or more approaches, based on the number of received return signals that have not been disregarded, and to allocate a duration of green light time for each of said plurality of traffic lights in response to the real-time number of vehicle size units located at a corresponding approach,
wherein said signal controller is operable to control operation of said plurality of traffic lights associated with said intersection in accordance with said allocated green light time.

12. (canceled)

13. (canceled)

14. The system according to claim 11, wherein the return signal is also modulated with an identifier of an instantaneous travel direction of the vehicle which associates the vehicle to a signal group.

15. The system according to claim 11, wherein the signal controller transceiver is a signal controller radio transceiver for transmitting and receiving radio wave signals.

16. The system according to claim 11, wherein the signal controller transceiver comprises a plurality of stationary directional antennas, an interrogating signal transmitted from each of said antennas being propagatable to a different approach.

17. The system according to claim 11, wherein the directional antenna of the control unit is rotatable to predetermined discrete angular positions, from each of said predetermined angular positions the interrogating signal is propagatable to a different approach.

18. The system according to claim 15, wherein both the directional antenna of the control unit and the directional antenna of the vehicle unit have a limited spatial sector, and wherein the interrogating signal is modulated with both an identifier of the control unit from which it was transmitted and with an identifier of the approach to which it propagatable.

19. The system according to claim 11, wherein the SCIPU is also operable to determine a real-time number of vehicles that are waiting at an approach to an upstream intersection in order to adjust the duration of allocated green light time of an intersection downstream to said upstream intersection.

20. The system according to claim 19, wherein the SCIPU is operable to count a real-time number of vehicles that are waiting at an approach to the upstream intersection by temporarily disregarding all return signals modulated with the UBC of the interrogating signal transmitted by the control unit of the intersection downstream to the upstream intersection and to determine that a vehicle is located on an approach to the upstream intersection if all return signals transmitted by its vehicle unit which are received and not disregarded by the downstream intersection control unit are modulated with the UBC of an interrogating signal transmitted by said upstream intersection control unit.

21. The system according to claim 11, wherein the vehicle processing unit is operable to modulate the return signal with a randomly generated identifier of the vehicle unit.

22. The system according to claim 15, wherein the SCIPU is operable to disregard a return signal when said control unit determines that the value of RSSI decreases with time, the value of all received signal strength indications from said vehicle unit is lower than a predetermined threshold, or the USC of said interrogating signal with which said return signal is modulated originated from another approach of said intersection, or is operable to disregard all return signals having a common VBC when one of the UBCs modulated with said common VBC originated from an upstream control unit.

23. The system according to claim 11, wherein the vehicle processing unit is operable to disregard an interrogating signal originated from another vehicle processing unit.

24. (canceled)

25. (canceled)

26. The system according to claim 14, in which the green light time is allocated by:
a. compiling, for each signal group, a list of vehicles waiting for green light time;
b. sequentially removing a vehicle from the waiting list after said vehicle crosses the intersection;
c. comparing, for each signal group, a determined number of vehicles on the waiting list with a number of vehicles that have crossed the intersection; and
d. adjusting the allocated green light time if a difference between the determined number of vehicles on the waiting list and the number of vehicles that have crossed the intersection is greater than, or less than, a predetermined range of values.

27. The method according to claim 1, wherein the return signal is also disregarded when the control unit determines that the values of all received signal strength indications from the vehicle unit are lower than a predetermined threshold, or when the control unit determines that the identifier of the interrogating signal with which the return signal is modulated has been originated from another approach of the intersection, or when the control unit determines that the value of signal strength indication, received from the vehicle unit, decreases with time, or when one of the UBCs modulated with a common VBC originated from an upstream control unit.
